(19) United States
(12) Patent Application Publication
(10) Pub. No.: US 2021/0096008 A1
(43) Pub. Date: Apr. 1, 2021

(54) Rod Shaped Measuring Electrode for a Magnetic Inductive Flow Meter

(71) Applicant: Siemens Aktiengesellschaft, Muenchen (DE)

(72) Inventors: Pascal AITBRAHAM, Haguenau (FR); Christophe BERSWEILER, Bischheim (FR); Stefan DENNELER, München (DE); Wei-Dong KANG, Peterborough (CA); Frederic LIENHART, Bernolsheim (FR); Friedrich LUPP, Gauting (DE); Baptiste MEYER, Schiltigheim (FR); Carsten SCHUH, Baldham (DE); Baljinder SINGH, Peterborough (CA); Marjorie VEIT, Batzendorf (FR)

(21) Appl. No.: 17/033,071

(22) Filed: Sep. 25, 2020

(30) Foreign Application Priority Data
Sep. 27, 2019 (DE) 102019214915.4

(51) Int. Cl. G01F 1/58

(52) U.S. Cl. CPC G01F 1/584; G01F 1/586

(57) ABSTRACT

A rod-shaped measuring electrode (6, 7) for a magnetic-inductive flow meter includes an end face (15) provided at one end of the rod for contact with a measuring medium and includes a plurality of layers (17) made alternately of a ceramic coating (18) and a metal coating (19) extending in the longitudinal direction of the rod over the length thereof.

### BACKGROUND OF THE INVENTION

### 1. Field of the Invention

The invention relates to a rod-shaped measuring electrode for a magnetic-inductive flow meter having a ceramic measuring tube, a ceramic measuring tube having such a measuring electrode and to a magnetic-inductive flow meter having such a measuring tube.

### 2. Description of the Related Art

In general, magnetic-inductive flow meters consist of a magnetically non-conductive measuring tube with an electrically non-conductive inner surface, magnetic coils arranged diametrically externally on the measuring tube and at least two measuring electrodes, which are routed though the tube wall and are in contact with a measuring medium flowing through the tube. With the help of the magnetic coils, a clocked magnetic field is generated, which permeates the measuring tube and the measuring medium flowing therein perpendicularly to the direction of flow. A signal voltage, which is tapped with the help of the measuring electrodes and is then evaluated, is generated in the measuring medium that must have an electrical conductivity greater than a minimum conductivity.

High demands on corrosion resistance with respect to the measuring medium, on pressure and temperature stability, and on the impermeability of the measuring electrode lead-throughs exist for the measuring tube and the measuring electrodes. The measuring electrodes must additionally ensure a good electrical transition to the measuring medium.

DE 10 2005 029 324 A1 proposes, because of the high material costs for platinum or other suitable precious metals, two-part measuring electrodes with a head section that is in contact with the measuring medium and is made of a precious metal or a precious metal alloy with, for example, platinum, gold or tantalum as the main component, and with a shaft section made of a non-precious metal or a metal alloy with iron, zinc or copper, for example, as the main component.

As is known from DE 43 35 697 A1 , for example, measuring tubes made of ceramic to a great extent fulfill the aforementioned requirements for corrosion resistance, and pressure and temperature stability, but the production of highly impermeable lead-throughs of metal electrodes is difficult. Hence measuring electrodes made of cermet, a composite material consisting of ceramic and metal (e.g. platinum) have been proposed. A cermet measuring electrode formed as a rod can be thus placed into a drill hole of the green ceramic of the measuring tube and sintered together therewith. During sintering, the ceramic content of the measuring electrode combines with the surrounding ceramic, where a ceramic joining zone without any potential leakage between the measuring tube and the measuring electrode is created.

In view of the high costs for platinum, on the one hand, and the lower electrical conductivity of conductive ceramic material compared to metals, on the other hand, DE 36 27 993 A1 describes the formation of the measuring electrode from a ceramic core rod that is coated with a high-melting metal, such as platinum or a platinum-iridium alloy, along its longitudinal extent and on the end face that is in contact with the measuring medium. As a result of the coating, the amount of metal required can be reduced and additionally the diameter of the measuring electrode can be increased, in order thus to achieve a low impedance of the measuring electrode. The sintered or semi-sintered metal-coated core rod is inserted into a hole in a non-sintered or semi-sintered ceramic measuring tube and is sintered together therewith.

Similar problems as described in DE 43 35 697 A1 for sintering platinum measuring electrodes into ceramic measuring tubes can occur in the case of this measuring electrode lead-through with respect to the interface between the metal coating of the core rod and the ceramic of the measuring tube.

DE 10 2005 002 904 A1 discloses an electrode for a magnetic-inductive flow meter, which has a measuring tube made of metal with an inner tube lining made of a plastic material. The electrode comprises a T-shaped substrate made of stainless steel, whose substrate longitudinal beam is routed in an electrically insulated manner in an opening in the measuring tube and whose substrate cross-beam is fitted in a hermetically sealed manner into a recess in the inner lining of the measuring tube. At least one first thin-layer made of a precious metal, such as platinum or gold, is applied to the substrate cross-beam and a second thin-layer made of an electrically conductive ceramic, such as titanium nitride or aluminum titanium nitride, is applied thereover. The two-layer coating is formed at least on the side of the substrate facing the interior of the measuring tube.

### SUMMARY OF THE INVENTION

It is an object of the invention to provide an alternative measuring electrode with a reduced percentage of precious metal for a magnetic-inductive flow meter having a ceramic measuring tube.

This and other objects and advantages are achieved in according with the invention by a rod-shaped measuring electrode for a magnetic-inductive flow meter with a ceramic measuring tube, with an end face provided at one end of the rod for contact with a measuring medium and with a plurality of layers that extend in the longitudinal direction of the rod over the length thereof and are that made alternately of a ceramic coating and a metal coating comprising a precious metal or a precious metal alloy.

It is also an object of the invention to provide a ceramic measuring tube for a magnetic-inductive flow meter with holes in which such a measuring electrode is inserted, in particular is sintered in, as well as a magnetic-inductive flow meter having such a measuring tube.

The measuring electrode cannot be of an arbitrary thickness and must have a minimum diameter to produce measuring electrode and to be able to insert it into the measuring tube of the magnetic-inductive flow meter. In the case of the inventive measuring electrode the effective electrode surface for the measuring medium formed from the metal coating exposed on the end face and the percentage by volume of the metal both depend on the thickness of the metal coating, the thickness of the ceramic coating, and the number of layers. Hence, for a given diameter of the measuring electrode, effective electrode surfaces of different sizes can be achieved along with a reduced percentage of precious metal.

The layers made alternately of the ceramic and metal coating can be helical or run concentrically about the longitudinal axis of the rod-shaped measuring electrode. The layers can, however, also be formed in parallel planes.

The ceramic coating can be produced using different casting, spray or pressure methods. Advantageously, they can consist of a ceramic tape that can be wound up to form a cylindrical coil, for example, after application of the metal coating.

The measuring electrode can for example, be produced based on green ceramic and then inserted into the hole in the measuring tube and sintered together therewith. For this purpose, the measuring electrode is preferably structured such that the outermost layer is formed from the ceramic coating.

To further reduce the outlay in material and costs for the metal coating, the percentage of precious metal contained therein can decrease over the length of the measuring electrode from at least approximately 70% to 100% at the end in contact with the measuring medium to at least approximately 0% at the other end. Additionally or alternatively, the metal coating can be continuous near the end of the measuring electrode in contact with the measuring medium and be formed in a discontinuous manner in the direction of the other end.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained below using exemplary embodiments and with reference to the figures in the drawings, in which:

FIG. 1 shows a magnetic-inductive flow meter in accordance with the invention;

FIGS. 2 and 3 show exemplary rod-shaped measuring electrodes in accordance with the invention;

FIGS. 4 to 9 show end faces of the measuring electrode intended for contact with a measuring medium in different electrode configurations in accordance with the invention;

FIG. 10 shows an example of a layer made of a ceramic coating and a metal coating; and

FIG. 11 shows an exemplary round-wound measuring electrode with a composition of the metal coating which varies over the length in accordance with the invention.

### DETAILED DESCRIPTION OF THE EXEMPLARY EMBODIMENT

The same reference characters have the same meaning in the different figures. The illustrations are purely schematic and do not represent size ratios.

FIG. 1 shows a simplified schematic illustration of the block diagram of a magnetic-inductive flow meter 1 with a measuring tube 2 made of ceramic, such as aluminum oxide or partially stabilized zirconium oxide. A measuring medium 3 flows through the measuring tube 2 and is electrically conductive at least to a slight extent. Two measuring electrodes 6, 7 that are in contact with the measuring medium 3 flowing through are inserted in two diametrically opposing holes 4, 5 in the measuring tube 2. Two magnetic coils 8, 9 are arranged diametrically opposite externally on the measuring tube 2 and transversely to the connecting section between the electrodes 6, 7. The magnetic coils 8, 9 are supplied from a driver circuit 10 with a current that is periodically switched on or off or whose polarity is reversed, and generate a clocked magnetic field or alternating magnetic field 11 permeating the measuring tube 6 and the measuring medium 3 flowing therein. As a result of the flow of the measuring medium 3 running transversely to the magnetic field 11, a measuring voltage is induced that is tapped across both the measuring electrodes 6, 7 and that is then evaluated in an evaluation device 12 to form a measuring result 13 for the flow of the measuring medium 3.

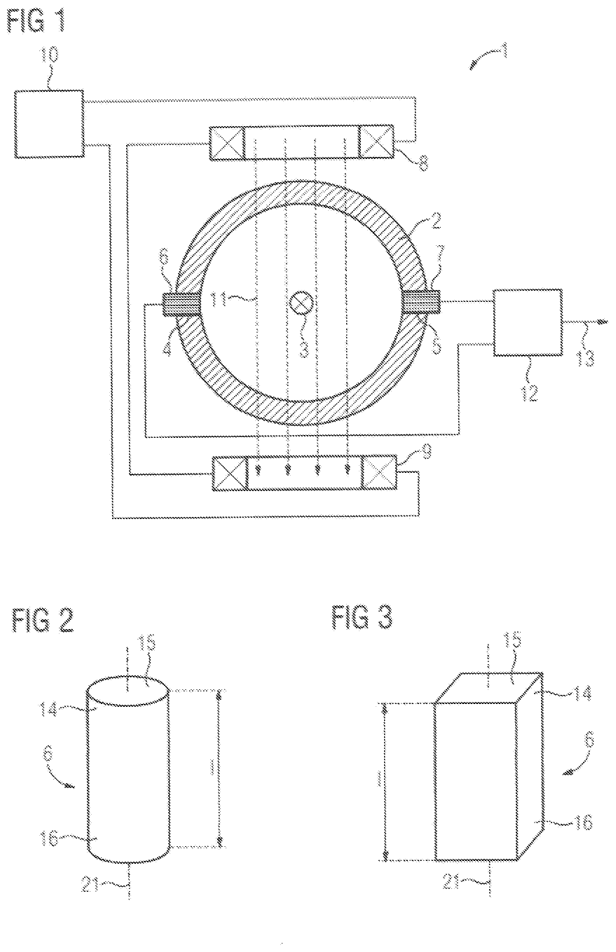

FIG. 2 shows by way of example one of the two structurally identical measuring electrodes 6, 7, in this case the measuring electrode 6, in the form of a rod with a circular cross-section. The end face 15 present at one end 14 of the rod serves for contact with the measuring medium 3, whereas the other end 16 of the measuring electrode 6, 7 serves for contact with a connecting line to the evaluation device 12.

FIG. 3 shows a further example of the rod-shaped measuring electrode 6 with a rectangular cross-section.

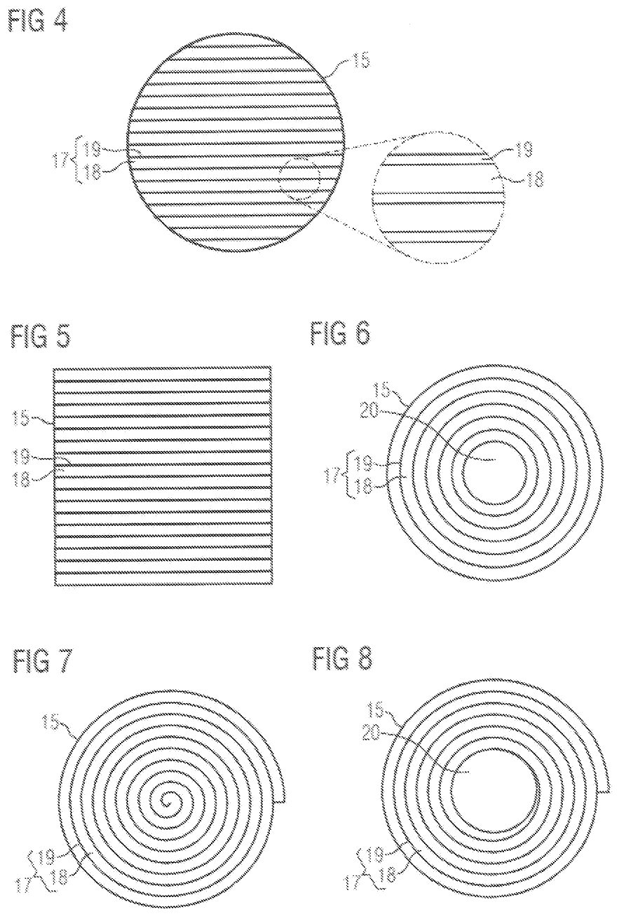

FIG. 4 shows an example of the rod-shaped measuring electrode 6 of FIG. 2 with a circular cross-section and with a view of the end face 15. The measuring electrode 6 consists of a plurality of layers 17 of alternately a ceramic coating 18 and a metal coating 19. In the example shown here, the layers 17 are arranged in parallel planes, where they extend in the longitudinal direction of the rod-shaped measuring electrode 6 over the length 1 thereof (FIG. 2).

FIG. 5 shows an example of the rod-shaped measuring electrode 6 with a rectangular cross-section shown in FIG. 3 and with a view of the end face 15. Here, the measuring electrode 6 also consists of a plurality of layers 17 of alternately a ceramic coating 18 and a metal coating 19 extending in parallel planes.

FIG. 6 shows a further example of the measuring electrode 6 of FIG. 2 with a circular cross-section and with a view of the end face 15. Here the layers 17 consisting alternately of the ceramic coating 18 and the metal coating 19 are applied to a core rod 20 and run concentrically-cylindrically about the longitudinal axis 21 (FIG. 2) of the rod-shaped measuring electrode 6.

In the example shown in FIG. 7 the layers 17 made alternately of the ceramic coating 18 and the metal coating 19 extend helically about the longitudinal axis 21 of the rod-shaped measuring electrode 6.

In the example shown in FIG. 8, the layers 17 made alternately of the ceramic coating 18 and the metal coating 19 are wound helically on the core rod 20.

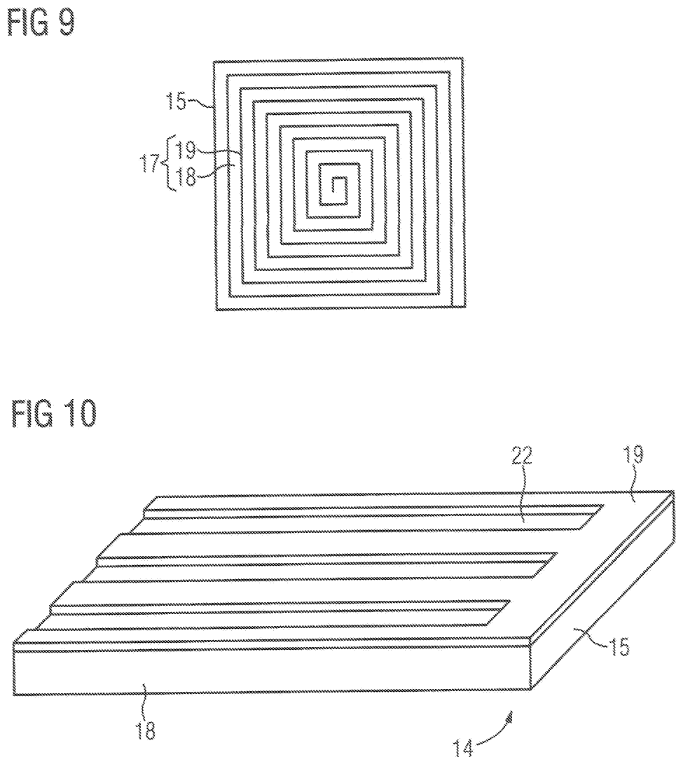

Lastly, FIG. 9 shows an example of the measuring electrode 6 of FIG. 3 with a rectangular cross-section and with a view of the end face 15. Here, the layers 17 consisting alternately of the ceramic coating 18 and the metal coating 19 extend in a rectangular-helical manner about the longitudinal axis 21 (FIG. 3) of the rod-shaped measuring electrode 6.

The metal coating 19 consists substantially or to a large extent of platinum or a platinum alloy, where other precious metals or precious metal alloys can also be considered. The electrode surface that is effective for the measuring medium 3 is formed by the metal coating 19 exposed on the end face 15 and depends on the thickness of the metal coating 19, the thickness of the ceramic coating 18 and the number of layers 17. In the case of the example of FIG. 7, an effective electrode surface of 0.34 mm² is achieved, for example, with a 100 μm thick ceramic coating 18, a 5 μm thick metal coating 19 and 14 coils. The diameter of the measuring electrode 6 is then 3 mm and the percentage by volume of the metal is 5%. To increase the contact to the measuring medium 3 or to adjust the contact impedance, the end face 15 can, if necessary, be overlaid with the metal of the metal coating 19.

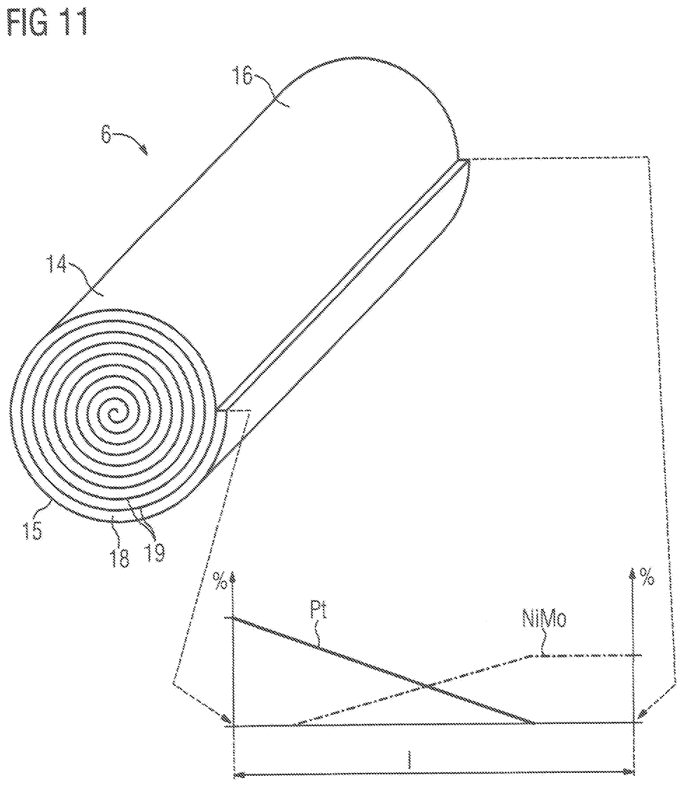

FIG. 10 shows part of a layer 17 with the ceramic coating 18 and the metal coating 19 in the region of the end 14 of the measuring electrode 6, where the measuring electrode 6 is in contact with the measuring medium 3 via its end face 15. In the region of the end 14, in particular at the end face 15, the metal coating 19 is continuous, whereas in the direction of the other end 16 the metal coating 19 contains discontinuities 22. As a result of the discontinuities 22, the outlay in materials and costs for the metal coating 19 can be further reduced. Depending on the embodiment of the discontinuities 22, different discontinuous, e.g. reticular metal structures, can be realized.

FIG. 11 shows by way of example a perspective illustration of the measuring electrode 6 of FIG. 7. The metal coating 19 contains, on the one hand, a precious metal (or precious metal alloy), such as platinum, in order to achieve a good electrical and corrosion-free contact to the measuring medium 3 at the end face 15 of the measuring electrode 6 and on the other hand a less expensive, likewise high-melting metal (or metal alloy), such as nickel, a nickel-molybdenum alloy, tantalum, or for example also graphite, to enable a connection by means of an electrical line to the evaluation device 12 (FIG. 1) by soldering, welding, bonding, etc. As shown, the percentage % of the precious metal, here Pt, decreases over the length 1 of the measuring electrode 6 from a high value (e.g. 70% to 100%) at the end 14 to a low value (e.g. 0%) at the other end 16. The percentage % of the non-precious metal, e.g. NiMo, increases in the same direction from the one end 14 of the measuring electrode 6 to the other end 16.

In the exemplary embodiment depicted in FIG. 6, the concentric-cylindrical ceramic coatings 18 and metal coatings 19 can be applied one after the other by suitable coating methods on the ceramic core rod 20, where cutting to the length 1 of the measuring electrodes 6 to be produced also occurs at the end.

Otherwise, the ceramic coating 18 can be produced from a ceramic tape, which in the case of the examples shown in FIGS. 7 to 9 can be wound to form a cylindrical coil after application of the metal coating 19. In the case of the example of FIG. 8, the winding occurs on the core rod 20, which likewise consists of ceramic. The coil, whose length can be a multiple of the length 1 of the measuring electrodes 6 to be produced, is ultimately cut to the length of the measuring electrodes 6.

In the exemplary embodiments depicted in FIGS. 4 and 5, a tape stack is formed from the metal-coated ceramic tape, and is likewise cut to the size of the measuring electrodes 6 to be produced.

The metal coating 19 can be applied to the ceramic 18 using suitable methods, e.g., spray or pressure methods.

The measuring electrodes 6, 7 and the measuring tube 2 can be produced based on green ceramic in a first step. The measuring electrodes 6, 7 are then inserted into the holes 4, 5 in the measuring tube 2 and lastly are sintered together therewith. For this purpose, the measuring electrode 6, 7 is preferably structured such that the outermost layer 17 is formed by the ceramic coating 18. To this end, for example, the ceramic tape can be wound with a metal coating facing inward. During sintering the ceramic contracts, such that intermediate spaces arising, for example, during the winding of the layers 17 close up. To be able to influence the degree of contraction or to adjust different degrees of contraction, the measuring electrodes 6, 7 can be pre-sintered before insertion into the holes 4, 5 in the measuring tube 2.

It is also possible to fasten ready-sintered measuring electrodes 6, 7 in the holes 4, 5 in the measuring tube 2, if necessary, with the help of a glass frit as a bonding material (glass frit bonding).

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A rod-shaped measuring electrode for a magnetic-inductive flow meter, the rod-shaped measuring electrode comprising:
a ceramic measuring tube;
an end face provided at one end of the rod-shaped measuring electrode for contact with a measuring medium;
a plurality of layers made alternately of a ceramic coating; and
a metal coating comprising a precious metal or a precious metal alloy extending in a longitudinal direction of the rod over a length thereof.

2. The rod-shaped measuring electrode as claimed in claim 1, wherein the plurality of layers extend helically about a longitudinal axis of the rod-shaped measuring electrode.

3. The rod-shaped measuring electrode as claimed in claim 1, wherein the plurality of layers extend concentrically about a longitudinal axis of the rod-shaped measuring electrode.

4. The rod-shaped measuring electrode as claimed in claim 1, wherein the plurality of layers extend in parallel planes.

5. The rod-shaped measuring electrode as claimed in claim 1, wherein the ceramic coating consists of a ceramic tape.

6. The rod-shaped measuring electrode as claimed in claim 1, wherein an outermost layer comprises a ceramic coating.

7. The rod-shaped measuring electrode as claimed in claim 1, wherein the metal coating contains the precious metal or the precious metal alloy, a percentage (%) of the precious metal or the precious metal alloy reducing over the length of the -shaped measuring electrode from at least approximately 70% to 100% at the one end to at least approximately 0% at another end.

8. The rod-shaped measuring electrode as claimed in claim 7, wherein the precious metal or the precious metal alloy comprises platinum.

9. The rod-shaped measuring electrode as claimed in claim 1, wherein the metal coating is continuous near the one end of the rod and is discontinuous in a direction of another end.

10. The rod-shaped measuring electrode as claimed in claim 1, wherein the end face provided for contact with the measuring medium is overlaid with metal of the metal coating.

11. A ceramic measuring tube for a magnetic-inductive flow meter having holes in which the rod-shaped measuring electrode as claimed in claim 1 is inserted.

12. The ceramic measuring tube for the magnetic-inductive flow meter as claimed in claim 11, wherein the rod-shaped measuring electrode is sintered into the holes.

13. A magnetic-inductive flow meter having the ceramic measuring tube as claimed in claim 12.
